(19) United States
(12) Patent Application Publication
(10) Pub. No.: US 2002/0104331 A1
(43) Pub. Date: Aug. 8, 2002

(54) Substrate having V-shaped grooves having multi-angled V-shaped grooves and manufacturing method therefor

(75) Inventors: Masashi Fukuyama, Inuyama-city (JP); Kazutoshi Tohyama, Nakatsugawa-city (JP)

Correspondence Address: BURR & BROWN, PO BOX 7068, SYRACUSE, NY, 13261-7068, US

(73) Assignee: NGK Insulators, Ltd.

(21) Appl. No.: 09/778,394

(22) Filed: Feb. 7, 2001

(51) Int. Cl. C03B 23/00; C03C 19/00

(52) U.S. Cl. 65/61; 65/64

(57) ABSTRACT

To provide a substrate having V-shaped grooves having multi-angled V-shaped grooves in which a slant face of the V-shaped grooves has two or more angles. A cross section of the V-shaped grooves is formed so that the angle that a straight line forming a groove above a contact point of a fiber with the V-shaped grooves makes with a tangential line at the contact point is an acute angle smaller than 180 degrees. The cross section of the V-shaped grooves may be formed so that the angle that a straight line forming a groove below a contact point of a fiber with the V-shaped grooves makes with a tangential line at the contact point is an acute angle smaller than 180 degrees. The substrate having V-shaped grooves having a slant face shape with two or more angles can be manufactured by grinding a glass substrate by using a diamond grinding stone having several types of tip end angles.

### BACKGROUND OF THE INVENTION AND RELATED ART STATEMENT

The present invention relates to a substrate having V-shaped grooves with two or more slant face angles of V-shaped grooves and a manufacturing method therefor.

In recent years, the laying and use of optical fibers have dramatically been in progress. As an optical fiber arrangement part, an optical fiber array for connecting the optical fiber to other optical parts is well known.

In the optical fiber array, a substrate having V-shaped grooves for mounting and arranging fibers in V-shaped grooves is used, and a circular fiber is mounted on the fiber arranging V-shaped grooves, so that normally, in order to maintain the accuracy, a fiber 1 is in contact with a slant face 2 of the V-shaped groove at two points of contact portions 3 as shown in FIG. 8.

Therefore, there is no problem if only the contact portions 3, which are portions where the fiber 1 is in contact with the slant face 2 of V-shaped grooves, are formed with high accuracy. In ordinary V-shaped grooves 4, a highly accurate shape is formed over the whole, by which the position of the fiber 1 is fixed with high accuracy.

As a result, a state in which an inscribed circle lies in a triangle is established, and spaces 5 around the fiber 1 are filled with adhesive to fix the fiber 1. Normally, an adhesive layer preferably has a thickness of about several micrometers to 20 micrometers. In many cases, however, the thickness of adhesive layer in the space 5 is about 50 μm. Therefore, since the coefficients of thermal expansion a of the fiber and the glass-made substrate having V-shaped grooves are about 10⁻⁷ to 10⁻⁶ while the coefficient of thermal expansion α of the cured adhesive is about 10⁻⁵ to 10⁻⁴, there occurs a stress due to a difference between shrinkage and expansion caused by residual shrinkage stress of adhesive that shrinks on curing by about 1 to 10% or by thermal change, which results in decreased long-term reliability of the optical fiber array.

Also, in the case of polarization fiber array using polarization fibers, the influence of adhesive in these spaces is remarkable, and in some cases, if the shrinkage stress is high, the polarization crosstalk characteristics cannot be maintained due to the stress, which leads to the restriction of the length of V-shaped grooves in designing and the restriction of adhesive.

Further, in order to maintain the reliability of optical fiber array, it is important that the area of bonding surface between the substrate having V-shaped grooves and an upper substrate (proper bonding layer thickness portion on both sides of V-shaped grooves) be secured to some degree. In many cases, however, the width cannot be increased indiscriminately because the fiber array has a high density.

In a conventional substrate having V-shaped grooves as shown in FIG. 9, since the V-shaped grooves 4 have a predetermined opening width, the area of a bonding surface 6 between the substrate having V-shaped grooves and an upper substrate 7 is small, so that the width dimension is restricted.

The present invention has been achieved to solve the problems with the conventional art, and accordingly an object thereof is to provide a substrate having V-shaped grooves, in which the volume of adhesive in V-shaped grooves is reduced by contriving the shape of V-shaped grooves, by which the adhesive stress is decreased and the opening width of V-shaped grooves is decreased so as to increase the area of bonding surface between the substrate having V-shaped grooves and a fiber fixing substrate, which is an upper substrate, thereby increasing the bonding strength, and a manufacturing method for the substrate having V-shaped grooves.

### SUMMARY OF THE INVENTION

According to the present invention, there is provided a substrate having V-shaped grooves having multi-angled V-shaped grooves in which a slant face of the V-shaped grooves has two or more angles, characterized in that a cross section of the V-shaped grooves is formed so that an angle that a straight line forming a groove above a contact point of a fiber with the V-shaped grooves makes with a tangential line at the contact point is an acute angle smaller than 180 degrees, and characterized in that the cross section of the V-shaped grooves is formed so that an angle that a straight line forming a groove below a contact point of a fiber with the V-shaped grooves makes with a tangential line at the contact point is an acute angle smaller than 180 degrees.

Also, according to the present invention, there is provided a manufacturing method for the above-described substrate having V-shaped grooves having multi-angled V-shaped grooves, characterized in that by grinding a glass substrate using a diamond grinding stone having several types of tip end angles, the substrate having V-shaped grooves having a slant face shape with two or more angles is manufactured.

Further, a mold can be manufactured by grinding with a diamond grinding stone, the mold having an inverse chevron shape corresponding to the above-described substrate having V-shaped grooves having multi-angled V-shaped grooves.

Also, the substrate having V-shaped grooves can be manufactured by press molding a glass substrate using the above-described mold having an inverse chevron shape.

In this case, as the press molding operation, it is preferable to use reheat press molding method in which molten glass is subjected to rough press molding operation to obtain a substrate having V-shaped grooves, the obtained substrate having V-shaped grooves is heated again to a temperature at which the substrate having V-shaped grooves is softened, and fine adjustment of shape is made precisely because the mold face can be transferred with high accuracy.

### BRIEF DESCRIPTION OF THE DRAWINGS

FIG. 1 is a sectional view for illustrating one embodiment of a substrate having V-shaped grooves in accordance with the present invention.

FIG. 2 is an enlarged sectional view showing another shape of V-shaped grooves of a substrate having V-shaped grooves in accordance with the present invention.

FIG. 3 is a schematic view showing a whole shape of a diamond grinding stone.

FIG. 4 is an enlarged view of a tip end portion of a diamond grinding stone.

FIG. 5 is a perspective view showing one embodiment of a mold used in the present invention.

FIG. 6 is a perspective view of a substrate having V-shaped grooves molded by using the mold shown in FIG. 5.

FIG. 7 is a sectional view showing still another embodiment in which still another shape of V-shaped grooves of a substrate having V-shaped grooves in accordance with the present invention is provided.

FIG. 8 is a sectional view for illustrating a state in which a fiber is mounted on a conventional substrate having V-shaped grooves.

FIG. 9 is a sectional view for illustrating a bonded state between a conventional substrate having V-shaped grooves and an upper substrate.

### DETAILED DESCRIPTION OF PREFERRED EMBODIMENT

Embodiments of the present invention will now be described in detail with reference to the accompanying drawings. The present invention is not limited to these embodiments.

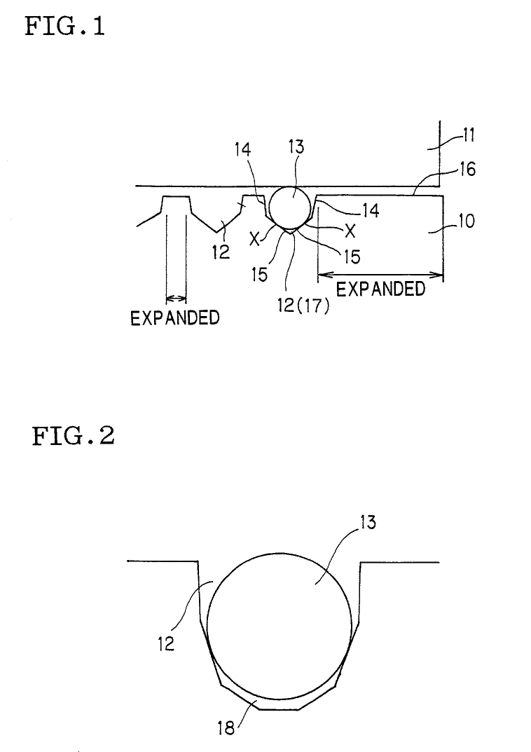

FIG. 1 is a sectional view for illustrating one embodiment of a substrate having V-shaped grooves in accordance with the present invention, and FIG. 2 is an enlarged sectional view showing another shape of V-shaped grooves of a substrate having V-shaped grooves in accordance with the present invention.

In FIG. 1, reference numeral 10 denotes a substrate having V-shaped grooves, and 11 denotes an upper substrate (fiber fixing substrate) which performs a function of pressing fibers 13 mounted in V-shaped groove 12 in the substrate having V-shaped grooves 10 from the upside. The V-shaped groove 12 has multi-angled V-shaped grooves with two slant face angles. In the case shown in FIG. 1, the cross section is formed so that the angle that a straight line 14 forming a groove above a contact point X of the fiber 13 with the V-shaped grooves 12 makes with a tangential line 15 at the contact point X is an acute angle smaller than 180 degrees.

By using the above-described substrate having V-shaped grooves, a space volume between the V-shaped grooves and the fiber is decreased, so that the quantity of adhesive filled in this portion can be reduced. As a result, the stress of adhesive can be decreased.

Also, as shown in FIG. 1, the opening width of the V-shaped grooves is made smaller than that of a conventional V-shaped grooves having a triangular shape in cross section, by which the optimum bonding area portion (bonding surface) 16 of the substrate having V-shaped grooves 10 with the fiber fixing substrate 11 can be increased. In this case, for a fiber array having a plurality of fiber fixing grooves (V-shaped grooves) 12 as well, by making only the outside slant face of an outermost V-shaped grooves 17 in the V-shaped groove portion have multi-angled V-shaped grooves with two or more angles, the above-described operation and effects can be achieved, so that this configuration is effective.

Needless to say, by making the individual V-shaped grooves have the shape in accordance with the present invention, the bonding surface (the optimum bonding area portion) parallel with the fiber fixing substrate can be expanded in a portions between the adjacent V-shaped grooves, so that the bonding strength can be increased. Therefore, this configuration is more desirable.

Also, as shown in FIG. 2, a space 18 at the bottom part of the V-shaped grooves 12 is formed so that the V-shaped groove slant face has a multi-angled shape with two or more angles, by which the space 18 is decreased in volume. Thereby, the stress of adhesive therein is relieved, so that the strength of the fiber array can be increased.

A U-groove construction has so far been used as a groove shape. For this shape, since a fiber comes in contact with the whole rounded surface, the whole rounded surface is required to have a highly accurate shape. Contrarily, since the positioning of a fiber is determined at two portions in the case of V-shaped grooves having a multi-angled slant face with two or more angles as in the present invention, the slant faces being not in contact with a fiber do not necessarily have a highly accurate shape. Therefore, the V-shaped groove shape in accordance with the present invention can be realized easily.

Also, in the case shown in FIG. 1, the cross section is formed so that the angle that a straight line 14 forming a groove above a contact point X of the fiber 13 with the V-shaped grooves 12 makes with a tangential line 15 at the contact point X is an acute angle smaller than 180 degrees. It is a matter of course that the cross section may be formed so that the angle that a straight line forming a groove below a contact point of the fiber with the V-shaped grooves makes with a tangential line at the contact point is an acute angle smaller than 180 degrees.

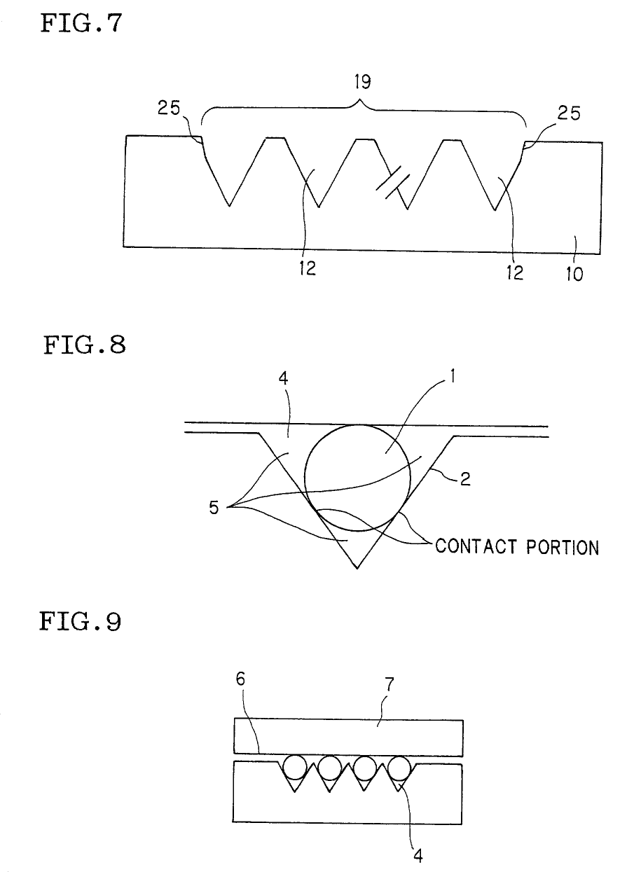

Further, in the present invention, as shown in FIG. 7, in the substrate having V-shaped grooves 10 on which a plurality of V-shaped grooves 12 are arranged, the effect can be achieved sufficiently by making only the outermost slant face 25 in a V-shaped groove arrangement group (V-shaped groove portion) 19 have a V-shaped groove shape having two or more angles.

Specifically, deterioration in fiber array is caused by water intruding from the outside. Water is liable to intrude from a portion where the substrate having V-shaped grooves is bonded to the upper substrate. According to the shape shown in FIG. 7, since a distance from the outside to the V-shaped grooves can be made large, the bonding surface can be increased, thereby the bonding strength can be improved. Also, since the distance from the outside to the V-shaped grooves is increased, a construction in which water etc. is less liable to intrude can be realized.

The following is a description of a manufacturing method for a substrate having V-shaped grooves in accordance with the present invention.

As a first method, a substrate having V-shaped grooves having multi-angled slant face shape with two or more angles as in the present invention can be manufactured by grinding with a diamond grinding stone. Since the tip end shape of diamond grinding stone can be fabricated arbitrarily, the substrate having V-shaped grooves having multi-angled slant face shape with two or more angles in accordance with the present invention can be manufactured easily. Therefore, the substrate having V-shaped grooves in accordance with the present invention can be manufactured by the same method as the conventional method.

As a second method, the substrate having V-shaped grooves in accordance with the present invention can be manufactured by reheat press molding.

Specifically, a mold having an inverse chevron shape corresponding to the predetermined V-shaped grooves construction to be manufactured is manufactured. By using this mold, a glass block, which has been cut off so as to have an almost the same volume as that of a pressed product, is heated to a softening temperature, and reheat press molding is performed to transfer the groove-shape of mold having a plurality of angles. Thereby, the substrate having V-shaped grooves in accordance with the present invention can be manufactured.

Next, the present invention will be described in more detail with reference to embodiments. The present invention is not limited to these embodiments.

### Embodiment 1

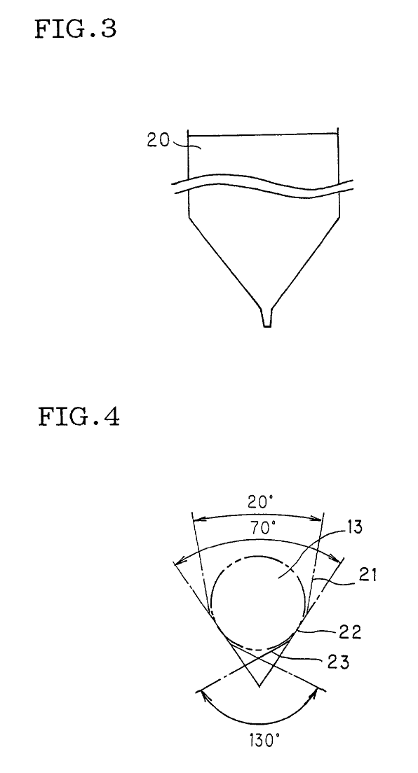

A substrate having V-shaped grooves in accordance with the present invention was manufactured by grinding. As grinding equipment, a microgrinder was used. Specifically, a diamond grinding stone 20 having a shape of tip end thereof as shown in FIGS. 3 and 4 was used. FIG. 3 shows the whole shape of the diamond grinding stone, and FIG. 4 enlargedly shows only the tip end shape of the grinding stone.

As shown in FIG. 4, by using the diamond grinding stone 20 having a plurality of types of tip end shapes, a substrate having V-shaped grooves having a slant face shape with three angles can be manufactured. The substrate having V-shaped grooves has slant faces 21 having an angle of 20 degrees, slant faces 22 having an angle of 70 degrees (in cross section, this slant face forms a tangential line at a contact point with a fiber 13), and slant faces 23 having an angle of 130 degrees which decreases a space at the bottom part of the V-shaped grooves.

By using a diamond #2000 metal grinding stone having the above-described shape, several steps of cutting operation were performed at a rotational speed of 10,000 rpm and at a fabrication speed of 20 mm/min to grind eight grooves in a glass substrate measuring 5 mm wide×8 mm long×2 mm thick. The measurement of V-shaped grooves was made by using a contact type shape measuring instrument. Only the straight lines with which a fiber is in contact were subjected to data analysis, and the dimensions of a fiber fixing portion were measured.

An optical fiber was mounted in this V-shaped grooves, and was pressed by an upper substrate from the upside, by which the fiber was fixed by only two contact points of V-shaped grooves with the fiber as shown in FIG. 4. Then, a space between the fiber and the substrate having V-shaped grooves was filled with an adhesive. In this embodiment, the angles were formed on the V-shaped grooves slant face in four steps.

### Embodiment 2

A substrate having V-shaped grooves in accordance with the present invention was manufactured by reheat press molding.

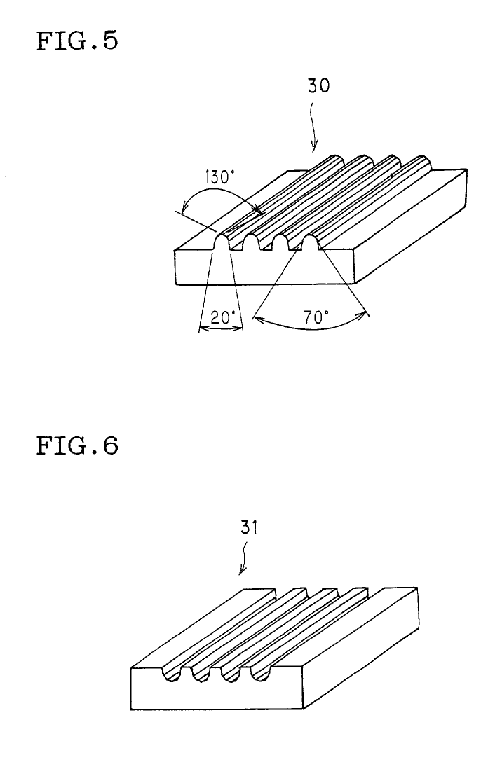

A carbide mold 30, shown in FIG. 5, having an inverse chevron shape corresponding to the V-shaped grooves construction shown in FIG. 4 was manufactured by using a diamond #2000 metal grinding stone.

By performing reheat press molding using this mold 30, a product 31 shown in FIG. 6 was molded. In reheat press molding, the dimensions are set considering the thermal expansion of mold and the thermal expansion of material. In the case of this embodiment, molding was preformed with a design value of 250 μm pitch. The transfer accuracy of reheat press molding was about 0.1 μm.

As a glass material for molded product, Miraclon PC-4 (trade name: made by NGK Insulators, Ltd.) was used, and molding was performed under conditions of a molding temperature of 600° C., a molding pressure of 1000 kg, and a molding period of 60 seconds.

As described above, according to the substrate having V-shaped grooves in accordance with the present invention, the volume of space between the V-shaped grooves and the fiber can be decreased, and the quantity of adhesive filled in this portion can be reduced, so that an effect that the stress of adhesive can be decreased is achieved.

What is claimed is:

1. A substrate having V-shaped grooves having multi-angled V-shaped grooves in which a slant face of the V-shaped grooves has two or more angles, characterized in that a cross section of said V-shaped grooves is formed so that an angle that a straight line forming a groove above a contact point of a fiber with the V-shaped grooves makes with a tangential line at the contact point is an acute angle smaller than 180 degrees.

2. A substrate having V-shaped grooves having multi-angled V-shaped grooves in which a slant face of the V-shaped grooves has two or more angles, characterized in that a cross section of said V-shaped grooves is formed so that an angle that a straight line forming a groove below a contact point of a fiber with the V-shaped grooves makes with a tangential line at the contact point is an acute angle smaller than 180 degrees.

3. A manufacturing method for a substrate having V-shaped grooves having multi-angled V-shaped grooves in which a slant face of the V-shaped grooves has two or more angles and the cross section of said V-shaped grooves is formed so that an angle that a straight line forming a groove above a contact point of a fiber with the V-shaped grooves makes with a tangential line at the contact point is an acute angle smaller than 180 degrees, characterized in that by grinding a glass substrate using a diamond grinding stone having several types of tip end angles, the substrate having V-shaped grooves having a slant face shape with two or more angles is manufactured.

4. A manufacturing method for a substrate having V-shaped grooves having multi-angled V-shaped grooves in which a slant face of the V-shaped grooves has two or more angles and the cross section of said V-shaped grooves is formed so that an angle that a straight line forming a groove below a contact point of a fiber with the V-shaped grooves makes with a tangential line at the contact point is an acute angle smaller than 180 degrees, characterized in that by grinding a glass substrate using a diamond grinding stone having several types of tip end angles, the substrate having V-shaped grooves having a slant face shape with two or more angles is manufactured.

5. A manufacturing method for a mold in which a mold is ground by using a diamond grinding stone, said mold having an inverse chevron shape corresponding to a substrate having V-shaped grooves having multi-angled V-shaped grooves in which a slant face of the V-shaped grooves has two or more angles and the cross section of said substrate having V-shaped groove is formed so that an angle that a straight line forming grooves above a contact point of a fiber with the V-shaped grooves makes with a tangential line at the contact point is an acute angle smaller than 180 degrees.

6. A manufacturing method for a mold in which a mold is ground by using a diamond grinding stone, said mold having an inverse chevron shape corresponding to a substrate having V-shaped grooves having multi-angled V-shaped grooves in which a slant face of the V-shaped grooves has two or more angles and the cross section of said substrate having V-shaped grooves is formed so that an angle that a straight line forming a groove below a contact point of a fiber with the V-shaped grooves makes with a tangential line at the contact point is an acute angle smaller than 180 degrees.

7. A manufacturing method for a substrate having V-shaped grooves having multi-angled V-shaped grooves, in which a glass substrate is press molded by the mold manufactured by the manufacturing method as set forth in claim 5.

8. A manufacturing method for a substrate having V-shaped grooves having multi-angled V-shaped grooves, in which a glass substrate is press molded by the mold manufactured by the manufacturing method as set forth in claim 6.

9. The manufacturing method for a substrate having V-shaped grooves having multi-angled V-shaped grooves as set forth in claim 7, characterized in that press molding consists of reheat press molding in which molten glass is subjected to rough press molding operation to obtain a substrate having V-shaped grooves, the obtained substrate having V-shaped grooves is heated again to a temperature at which said substrate having V-shaped grooves is softened, and fine adjustment of shape is made precisely.

10. The manufacturing method for a substrate having V-shaped grooves having multi-angled V-shaped grooves as set forth in claim 8, characterized in that the press molding consists of reheat press molding in which molten glass is subjected to rough press molding operation to obtain a substrate having V-shaped grooves, the obtained substrate having V-shaped grooves is heated again to a temperature at which said substrate having V-shaped grooves is softened, and fine adjustment of shape is made precisely.
